(19) United States
(12) Patent Application Publication
(10) Pub. No.: US 2015/0056412 A1
(43) Pub. Date: Feb. 26, 2015

(54) ARTICLE AND METHOD OF MAKING THE SAME

(71) Applicant: 3M INNOVATIVE PROPERTIES COMPANY, St. Paul, MN (US)

(72) Inventors: Ta-Hua Yu, Woodbury, MN (US); Moses M. David, Woodbury, MN (US); Albert I. Everaerts, Oakdale, MN (US); William Blake Kolb, West Lakeland, MN (US); Shunsuke Suzuki, Kawasaki (JP)

(21) Appl. No.: 14/385,827

(22) PCT Filed: Mar. 11, 2013
(86) PCT No.: PCT/US2013/030147

§ 371 Date: Sep. 17, 2014

Related U.S. Application Data
(60) Provisional application No. 61/615,630, filed on Mar. 26, 2012.

(51) Int. Cl. B05D 3/10; G02B 1/12; G02B 1/11

(52) U.S. Cl. CPC B05D 3/108; B05D 3/107; G02B 1/11; G02B 1/12
USPC 428/147; 427/379; 216/37; 428/141

(57) ABSTRACT

Article comprising an interpenetrating phase. Embodiments of the articles are useful, for example, for optical and optoelectronic devices, displays, solar, light sensors, eye wear, camera lens, and glazing.

### CROSS REFERENCE TO RELATED APPLICATION

This application claims the benefit of U.S. Provisional Patent Application No. 61/615,630, filed Mar. 26, 2012, the disclosure of which is incorporated by reference herein in its entirety.

### BACKGROUND

Functional coatings such as antireflection, antiscratch, barrier, antistatic, antismudge, and electromagnetic shielding coatings are increasingly being used on a variety of substrates. For high-end market applications such as displays and optical devices, mismatch in the inherent properties such as refractive index and chemistry nature between coatings and substrates can significantly impact optical, adhesion, and mechanical performance of the coated substrates.

Primed or pre-treated substrate surfaces are commonly used to enhance the interaction between functional coatings and substrates. Pre-treatments, however, add an additional process step and their effectiveness are sometimes limited by availability of the priming materials and aging effects.

### SUMMARY

Applicants have discovered an interpenetration interphase structure wherein in some embodiments, part of a coating (layer) and the substrate can co-exist to form a gradient in refractive index and strong interfacial bonding between the coating and substrate, where significantly improved coating quality, minimized interfacial reflection, and enhanced adhesion between the coating and substrate have been observed.

In one aspect, the present disclosure describes an article comprising a material having a thickness, first and second generally opposed major surfaces, and first and second regions across the thickness, wherein the first region is adjacent the first major surface, a layer comprising a polymeric material on the first major surface, and the polymeric material also present within the first region as a single phase with the substrate, wherein the thickness of the first region is at least 0.01 micrometer (in some embodiments, at least 0.025 micrometer, 0.05 micrometer, 0.075 micrometer, 0.1 micrometer, 0.5 micrometer, 1 micrometer, 1.5 micrometer, or even at least 2 micrometers; or even in a range from 0.01 micrometer to 0.3 micrometer, 0.025 micrometer to 0.3 micrometer, 0.05 micrometer to 0.3 micrometer, 0.075 micrometer to 0.3 micrometer, or 0.1 micrometer to 0.3 micrometer. In some embodiments, the layer comprises a nanoscale phase dispersed in the polymeric material. In some embodiments, the article exhibits an average reflection at 60 degrees off angle less than 1 percent (in some embodiments, less than 0.75 percent, 0.5 percent, 0.25 percent, or less than 0.2 percent). Additional details regarding articles exhibiting an average reflection at 60 degrees off angle less than 1 percent can be found in application having Ser. No. 61/615,646, filed Mar. 26, 2012, the disclosure of which is incorporated herein by reference.

Optionally, articles described herein have the second region adjacent the second major surface, a second layer comprising a second polymeric material on the second major surface, and the second polymeric material also present within the second region as a single phase with the substrate, wherein the thickness of the second region is at least 0.01 micrometer (in some embodiments, at least 0.025 micrometer, 0.05 micrometer, 0.075 micrometer, 0.1 micrometer, 0.5 micrometer, 1 micrometer, 1.5 micrometer, or even at least 2 micrometers; or even in a range from 0.01 micrometer to 0.3 micrometer, 0.025 micrometer to 0.3 micrometer, 0.05 micrometer to 0.3 micrometer, 0.075 micrometer to 0.3 micrometer, or 0.1 micrometer to 0.3 micrometer. In some embodiments, the second layer comprises a nanoscale phase dispersed in the polymeric material.

In another aspect, the present disclosure describes a method of making articles described herein, the method comprising:
providing a composition comprising polymeric precursor and optional solvent;
penetrating at least a portion of the polymeric precursor and optional solvent into a material through the first major surface of the material and providing a layer of the composition on the first major surface of the material;
removing the solvent if present (e.g., by drying); and
at least partially curing the polymeric precursor to provide a polymeric matrix. In some embodiments, the composition further comprises nanoscale phase dispersed therein.

In another aspect, the present disclosure describes a method of making articles described herein, the method comprising:
providing a composition comprising polymeric precursor and optional solvent;
penetrating at least a portion of the polymeric precursor and optional solvent into a material through the first major surface of the material and providing a layer of the composition on the first major surface of the material;
removing the solvent if present (e.g., by drying);
at least partially curing the polymeric precursor in the material to provide the single phase polymeric material and polymeric matrix with the nanoscale phase dispersed in a layer; and

anisotropically etching at least a portion of the polymeric matrix using plasma (e.g., a O₂, Ar, CO₂, O₂/Ar, O₂/CO₂, C₆F₁₄/O₂, or C₃F₈/O₂ plasma) to form the random anisotropic nanostructured surface.

Articles described herein can be used, for example, for creating high performance, low fringing, antireflective optical articles.

Embodiments of articles described herein are useful, for example, for numerous applications including optical and optoelectronic devices, displays, solar cells, light sensors, eye wear, camera lenses, and glazing.

### BRIEF DESCRIPTION OF THE DRAWINGS

FIG. 1 is a schematic of the cross-sectional view of material described herein comprising first and second regions across the thickness and a layer comprising nano-scale dispersed phase.

FIG. 2 is a transmission electron microscope (TEM) digital photomicrograph of a cross-section of Example 4.

FIG. 3 is a transmission electron microscope (TEM) digital photomicrograph of a cross-section of the Comparative Example.

### DETAILED DESCRIPTION

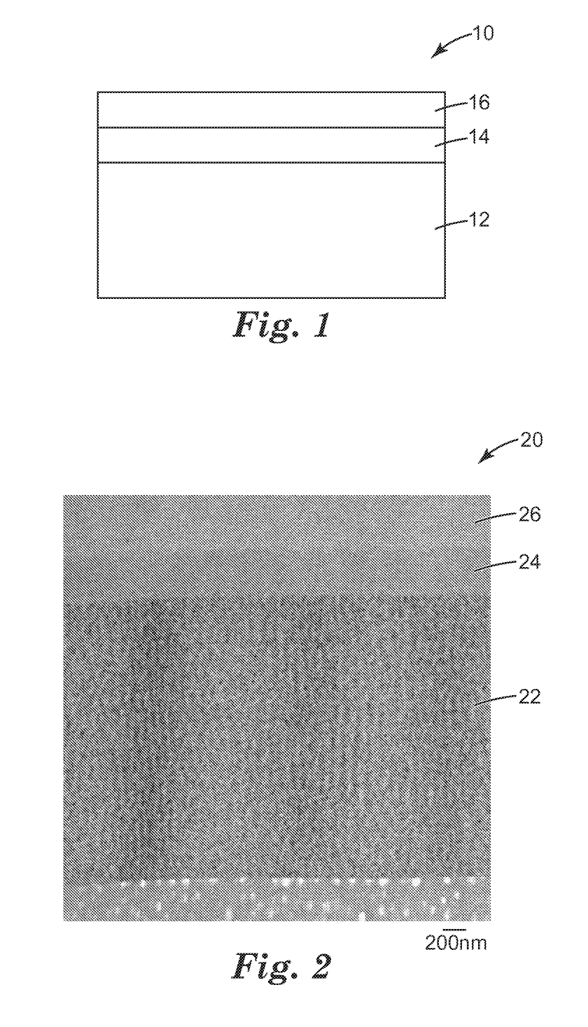

Referring to FIG. 1, article 10 described herein comprises material having first and second regions 14, 12, respectively, and polymeric material 16.

Examples of materials comprising the first and second regions include amorphous polymers such as triacetate cellulose (TAC), polyacrylates, polystyrene, polycarbonate, thermoplastic polyurethanes, polyvinyl chloride, polyvinylidene chloride, polyvinyl acetate, amorphous polyesters, poly(methyl methacrylate), acrylonitrile butadiene styrene, styrene acrylonitrile, cyclic olefin copolymers, polyimide, silicone-polyoxamide polymers, fluoropolymers, and thermoplastic elastomers. Semi-crystalline polymers such as polyethylene terephthalate (PET), polyamide, polypropylene, polyethylene, and polyethylene naphthalate can be also useful by a pre-treatment with flash lamp or flame to create amorphous skin. Typically these materials have a thickness in the range from 4 micrometers to 750 micrometers (in some embodiments, in a range from 25 micrometers to 125 micrometers). For display optical film applications, low birefringent polymeric substrates, such as triacetate cellulose, poly(methyl methacrylate), polycarbonate, and cyclic olefin copolymers, may be particularly desirable to minimize or avoid orientation induced polarization or dichroism interference with other optical components, such as polarizer, electromagnetic interference, or conductive touch functional layer in the optical display devices.

Examples of precursors include polymerizable resins comprising at least one oligomeric urethane (meth)acrylate. Typically the oligomeric urethane (meth)acrylate is multi(meth)acrylate. The term “(meth)acrylate” is used to designate esters of acrylic and methacrylic acids, and “multi(meth)acrylate” designates a molecule containing more than one (meth)acrylate group, as opposed to “poly(meth)acrylate” which commonly designates (meth)acrylate polymers. Typically, the multi(meth)acrylate is a di(meth)acrylate, although other examples include tri(meth)acrylates and tetra(meth)acrylates.

Oligomeric urethane multi(meth)acrylates are available, for example, from Sartomer under the trade designation “PHOTOMER 6000 Series” (e.g., “PHOTOMER 6010” and “PHOTOMER 6020”), under the trade designation “CN 900 Series” (e.g., “CN966B85”, “CN964”, and “CN972”). Oligomeric urethane (meth)acrylates are also available, for example, from Surface Specialties under the trade designations “EBECRYL 8402”, “EBECRYL 8807”, and “EBECRYL 4827”. Oligomeric urethane (meth)acrylates may also be prepared, for example, by the initial reaction of an alkylene or aromatic diisocyanate of the formula OCN—R3-NCO, wherein R3 is a C2-100 alkylene or an arylene group with a polyol. Most often, the polyol is a diol of the formula HO—R4-OH wherein R4 is a C2-100 alkylene group. Dependant on the diisocyanate or diol being used in excess, the intermediate product is then a urethane diisocyanate or urethane diol. Subsequently the urethane diisocyanate can undergo reaction with a hydroxyalkyl (meth)acrylate or the urethane diol can undergo reaction with an isocyanate functional (meth)acrylate, such as isocyanatoethyl methacrylate. Suitable diisocyanates include 2,2,4-trimethylhexylene diisocyanate and toluene diisocyanate. Alkylene diisocyanates are generally preferred. A particularly preferred compound of this type may be prepared from 2,2,4-trimethylhexylene diisocyanate, poly(caprolactone)diol, and 2-hydroxyethyl methacrylate. In at least some cases, the urethane (meth)acrylate is preferably aliphatic.

The polymerizable resins can be radiation curable compositions comprising at least one other monomer (i.e., other than an oligomeric urethane (meth)acrylate). The other monomer may reduce viscosity and/or improve thermomechanical properties and/or increase refractive index. The monomer may also facilitate diffusion into, and interpenetration with the substrate, and subsequently be cured to form a single phase with the substrate, which can be characterized as a homogeneous domain without phase separation by transmission electron microscopy. Monomers having these properties include acrylic monomers (i.e., acrylate and methacrylate esters, acrylamides, and methacrylamides), styrene monomers, and ethylenically unsaturated nitrogen heterocycles. Examples of UV curable acrylate monomers from Sartomer include “SR238”, “SR351”, “SR399”, and “SR444”.

Suitable acrylic monomers include monomeric (meth)acrylate esters. They include alkyl (meth)acrylates (e.g., methyl acrylate, ethyl acrylate, 1-propyl acrylate, methyl methacrylate, 2-ethylhexylacrylate, lauryl acrylate, tetrahydrofurfuryl acrylate, isooctylacrylate, ethoxyethoxyethylacrylate, methoxyethoxyethylacrylate, and t-butyl acrylate). Also included are (meth)acrylate esters having other functionality. Compounds of this type are illustrated by the 2-(N-butylcarbamyl)ethyl (meth)acrylates, 2,4-dichlorophenyl acrylate, 2,4,6-tribromophenyl acrylate, tribromophenoxyethyl acrylate, t-butylphenyl acrylate, phenyl acrylate, phenyl thioacrylate, phenylthioethyl acrylate, alkoxylated phenyl acrylate, isobornyl acrylate, and phenoxyethyl acrylate. The reaction product of tetrabromobisphenol A diepoxide, and (meth)acrylic acid is also suitable.

The other monomer may also be a monomeric N-substituted or N,N-disubstituted (meth)acrylamide, especially an acrylamide. These include N-alkylacrylamides and N,N-dialkylacrylamides, especially those containing C1-4 alkyl groups. Examples are N-isopropylacrylamide, N-t-butylacrylamide, N,N-dimethylacrylamide and N,N-diethylacrylamide.

The other monomer may further be a polyol multi(meth)acrylate. Such compounds are typically prepared from aliphatic diols, triols, and/or tetraols containing 2-10 carbon atoms. Examples of suitable poly(meth)acrylates are ethylene glycol diacrylate, 1,6-hexanediol diacrylate, 2-ethyl-2-hydroxymethyl-1,3-propanediol triacylate (trimethylolpropane triacrylate), di(trimethylolpropane) tetraacrylate, pentaerythritol tetraacrylate, the corresponding methacrylates, and the (meth)acrylates of alkoxylated (usually ethoxylated) derivatives of said polyols. Monomers having at least two (ethylenically unsaturated groups can serve as a crosslinker.

Styrenic compounds suitable for use as the other monomer include styrene, dichlorostyrene, 2,4,6-trichlorostyrene, 2,4,6-tribromostyrene, 4-methylstyrene, and 4-phenoxystyrene. Ethylenically unsaturated nitrogen heterocycles include N-vinylpyrrolidone and vinylpyridine.

In some embodiments, the polymeric material present within the first region is in a range from 5 wt. % to 75 wt. %, based on the total weight of the region including the polymeric material.

In some embodiments, the layer on the major surface of the materials described herein comprises a nano-dispersed phase and this nanoscale phase comprises submicrometer particles. In some embodiments, the submicrometer particles have an average particle size in a range from 1 nm to 100 nm (in some embodiments, 1 nm to 75 nm, 1 nm to 50 nm, or even 1 nm to 25 nm). In some embodiments, the submicrometer particles are covalently bonded to the polymeric matrix in the layer.

In some embodiments, articles described herein, the layer includes a nanostructured material. In some embodiments, the nanostructured material exhibits a random anisotropic nanostructured surface.

In some embodiments, the layer has a thickness of at least 500 nm (in some embodiments, at least 1 micrometer, 1.5 micrometer, 2 micrometer, 2.5 micrometers, 3 micrometers, 4 micrometers, 5 micrometers, 7.5 micrometers, or even at least 10 micrometers.

The polymeric material can be made from the monomeric materials described above, as well as tetrafluoroethylene, vinylfluoride, vinylidene fluoride, chlorotrifluoroethylene, perfluoroakoxy, fluorinated ethylene-propylene, ethylenetetrafluoroethylene, ethylenechlorotrifluoroethylene, perfluoropolyether, perfluoropolyoxetane, hexafluoropropylene oxide, siloxane, organosilicon, siloxides, ethylene oxide, propylene oxide, acrylamide, acrylic acid, maleic anhydride, vinyl acid, vinyl alcohol, vinylpyridine, and vinylpyrrolidone. In some embodiments, the polymeric matrix comprises at least one of acrylate, urethane acrylate, methacrylate, polyester, epoxy, fluoropolymer, or siloxane.

Examples of nanoscale phases include submicrometer particles. In some embodiments, the submicrometer particles have an average particle size in a range from 1 nm to 100 nm (in some embodiments, 1 nm to 75 nm, 1 nm to 50 nm, or even 1 nm to 25 nm). In some embodiments, the submicrometer particles are covalently bonded to the polymeric matrix in the layer.

In some embodiments, nanostructured materials described herein the nanoscale phase is present in less than 1.25 wt. % (in some embodiments, less 1 wt. %, 0.75 wt. %, 0.5 wt. %, or even less than 0.35 wt. %), based on the total weight of the polymeric matrix and nanoscale phase.

In some embodiments of nanostructured materials described herein include the nanoscale phase in a range from 60 nm to 90 nm in size, in a range from 30 nm to 50 in size, and less than 25 nm in size, wherein the nanoscale phase is present in a range from 0.25 wt. % to 50 wt. % (in some embodiments, 1 wt. % to 25 wt. %, 5 wt. % to 25 wt. %, or even 10 wt. % to 25 wt. %) for sizes in the range from 60 nm to 90 nm, 1 wt. % to 50 wt. % (in some embodiments, 1 wt. % to 25 wt. %, or even 1 wt. % to 10 wt. %) for sizes in the range from 30 nm to 50 nm, and 0.25 wt. % to 25 wt. % (in some embodiments, 0.5 wt. % to 10 wt. %, 0.5 wt. % to 5 wt. %, or even 0.5 wt. % to 2 wt. %) for sizes less than 25 nm), based on the total weight of the matrix and nanoscale phase.

In some embodiments of nanostructured materials described herein including the nanoscale phase in a range from 60 nm to 90 nm in size, in a range from 30 nm to 50 in size, and less than 25 nm in size, wherein the nanoscale phase is present in a range from 0.1 vol. % to 35 vol. % (in some embodiments, 0.5 vol. % to 25 vol. %, 1 vol. % to 25 vol. %, or even 3 vol. % to 15 vol. %) for sizes in a range from 60 nm to 90 nm, 0.1 vol. % to 25 vol. % (in some embodiments, 0.25 vol. % to 10 vol. %, or even 0.25 vol. % to 5 vol. %) for sizes in a range from 30 nm to 50 nm, and 0.1 vol. % to 10 vol. % (in some embodiments, 0.25 vol. % to 10 vol. %, or even 0.1 vol. % to 2.5 vol. %) for sizes less than 25 nm, based on the total volume of the matrix and nanoscale phase.

In some embodiments of nanostructured materials described herein including the nanoscale phase in a range from 1 nm to 100 nm in size wherein the nanoscale phase is present in a range less than 1.25 vol. %. (in some embodiments, less than 1 wt. %), based on the total volume of the matrix and nanoscale phase.

In some embodiments, nanostructured materials described herein exhibit a random anisotropic nanostructured surface. The nano-structured anisotropic surface typically comprises nanofeatures having a height to width ratio of at least 2:1 (in some embodiments, at least 5:1, 10:1, 25:1, 50:1, 75:1, 100:1, 150:1, or even at least 200:1). Exemplary nanofeatures of the nano-structured anisotropic surface include nano-pillars or nano-columns, or continuous nano-walls comprising nano-pillars, nano-columns, anistropic nano-holes, or anisotropic nano-pores. Preferably, the nanofeatures have steep side walls that are roughly perpendicular to the functional layer-coated substrate. In some embodiments, the nano features are capped with dispersed phase material. The average height of the nanostructured surface can be from 100 nm to 500 nm with a standard deviation ranged from 20 nm to 75 nm. The nanostructural features are essentially randomized in the planar direction.

In some embodiments of nanostructured materials described herein having the nanostructured material comprising the nanoscale phase, the nanoscale phase comprises submicrometer particles. In some embodiments, the submicrometer particles have an average particle size in a range from 1 nm to 100 nm (in some embodiments, 1 nm to 75 nm, 1 nm to 50 nm, or even 1 nm to 25 nm). In some embodiments, the submicrometer particles are covalently bonded to the polymeric matrix.

Examples of submicrometer particles dispersed in the matrix have a largest dimension less than 1 micrometer. Submicrometer particles include nanoparticles (e.g., nanospheres, and nanocubes). The submicrometer particles can be associated or unassociated or both.

The sub-micrometer particles can comprise carbon, metals, metal oxides (e.g., SiO₂, ZrO₂, TiO₂, ZnO, magnesium silicate, indium tin oxide, and antimony tin oxide), carbides (e.g., SiC and WC), nitrides, borides, halides, fluorocarbon solids (e.g., poly(tetrafluoroethylene)), carbonates (e.g., calcium carbonate), and mixtures thereof. In some embodiments, sub-micrometer particles comprises at least one of SiO₂ particles, ZrO₂ particles, TiO₂ particles, ZnO particles, Al₂O₃ particles, calcium carbonate particles, magnesium silicate particles, indium tin oxide particles, antimony tin oxide particles, poly(tetrafluoroethylene) particles, or carbon particles. Metal oxide particles can be fully condensed. Metal oxide particles can be crystalline.

In some embodiments, the sub-micrometer particles can be monodisperse (all one size or unimodal) or have a distribution (e.g., bimodal, or other multimodal).

Exemplary silicas are commercially available, for example, from Nalco Chemical Co., Naperville, Ill., under the trade designation “NALCO COLLOIDAL SILICA,” such as products 2329, 2329K, and 2329 PLUS. Exemplary fumed silicas include those commercially available, for example, from Evonik Degusa Co., Parsippany, N.J., under the trade designation, “AEROSIL series OX-50”, as well as product numbers -130, -150, and -200; and from Cabot Corp., Tuscola, Ill., under the designations “PG002”, “PG022”, “CAB-O-SPERSE 2095”, “CAB-O-SPERSE A105”, and “CAB-O-SIL M5”. Other exemplary colloidal silica is available, for example, from Nissan Chemicals under the designations “MP1040”, “MP2040”, “MP3040”, and “MP4040”.

In some embodiments, the sub-micrometer particles are surface modified. Preferably, the surface-treatment stabilizes the sub-micrometer particles so that the particles are well dispersed in the polymerizable resin, and result in a substantially homogeneous composition. The sub-micrometer particles can be modified over at least a portion of its surface with a surface treatment agent so that the stabilized particles can copolymerize or react with the polymerizable resin during curing.

In some embodiments, the sub-micrometer particles are treated with a surface treatment agent. In general, a surface treatment agent has a first end that will attach to the particle surface (covalently, ionically or through strong physisorption) and a second end that imparts compatibility of the particle with the resin and/or reacts with the resin during curing. Examples of surface treatment agents include alcohols, amines, carboxylic acids, sulfonic acids, phosphonic acids, silanes, and titanates. The preferred type of treatment agent is determined, in part, by the chemical nature of the metal oxide surface. Silanes are preferred for silica and other for siliceous fillers. Silanes and carboxylic acids are preferred for metal oxides, such as zirconia. The surface modification can be done either subsequent to mixing with the monomers or after mixing. It is preferred in the case of silanes to react the silanes with the particles or nanoparticle surface before incorporation into the resins. The required amount of surface modifier is dependent on several factors such as particle size, particle type, molecular weight of the modifier, and modifier type.

Representative embodiments of surface treatment agents include compounds such as isooctyl tri-methoxy-silane, N-(3-triethoxysilylpropyl)methoxyethoxy-ethoxyethyl carbamate (PEG3TES), N-(3-triethoxysilylpropyl)methoxyethoxyethoxyethyl carbamate (PEG2TES), 3-(methacryloyloxy)propyltrimethoxysilane, 3-acryloxypropyltrimethoxysilane, 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, vinyldimethylethoxysilane, pheyltrimethaoxysilane, n-octyltrimethoxysilane, dodecyltrimethoxysilane, octadecyltrimethoxysilane, propyltrimethoxysilane, hexyltrimethoxysilane, vinylmethyldiactoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-(2-(2-methoxyethoxy)ethoxy)acetic acid (MEEAA), beta-carboxyethylacrylate, 2-(2-methoxyethoxy)acetic acid, methoxyphenyl acetic acid, and mixtures thereof. One exemplary silane surface modifier is commercially available, for example, from OSI Specialties, Crompton South Charleston, W. Va., under the trade designation “SILQUEST A1230”. For mono-functional silane coupling agents comprising silanol groups, the silane agents can react and form covalent bonds with the hydroxyl groups on the surface of nanopartilces. For bi or multi-functional silane coupling agents comprising silanol groups and other functional groups (e.g., acrylate, epoxy, and/or vinyl), the silane agents can react and form covalent bonds with the hydroxyl groups on the surface of nanoparticles and the functional groups (e.g., acrylate, epoxy, and/or vinyl) in the polymeric matrix.

Surface modification of the particles in the colloidal dispersion can be accomplished in a variety of ways. The process involves the mixture of an inorganic dispersion with surface modifying agents. Optionally, a co-solvent can be added at this point, such as 1-methoxy-2-propanol, ethanol, isopropanol, ethylene glycol, N,N-dimethylacetamide, and 1-methyl-2-pyrrolidinone. The co-solvent can enhance the solubility of the surface modifying agents as well as the surface modified particles. The mixture comprising the inorganic sol and surface modifying agents is subsequently reacted at room or an elevated temperature, with or without mixing. In one method, the mixture can be reacted at about 85° C. for about 24 hours, resulting in the surface modified sol. In another method, where metal oxides are surface modified, the surface treatment of the metal oxide can preferably involve the adsorption of acidic molecules to the particle surface. Surface modification of the heavy metal oxide preferably takes place at room temperature.

Surface modification of ZrO₂ with silanes can be accomplished under acidic conditions or basic conditions. In one example, the silanes are heated under acid conditions for a suitable period of time. At which time the dispersion is combined with aqueous ammonia (or other base). This method allows removal of the acid counter ion from the ZrO₂ surface as well as reaction with the silane. In another method, the particles are precipitated from the dispersion and separated from the liquid phase.

A combination of surface modifying agents can be useful, for example, wherein at least one of the agents has a functional group co-polymerizable with a crosslinkable resin. For example, the polymerizing group can be ethylenically unsaturated or a cyclic group subject to ring opening polymerization. An ethylenically unsaturated polymerizing group can be, for example, an acrylate or methacrylate, or vinyl group. A cyclic functional group subject to ring opening polymerization generally contains a heteroatom, such as oxygen, sulfur, or nitrogen, and preferably a 3-membered ring containing oxygen (e.g., an epoxide).

Optionally, at least some of the submicrometer particles are functionalized with at least one multifunctional silane coupling agent comprising silanol and at least one of acrylate, epoxy, or vinyl functional groups. Typically, the coupling agents and submicronmeter particles are mixed in solvents allowing silanol coupling agents to react with hydroxyl groups on the surface of submicrometer particles and form covalent bonds with particles at elevated temperatures (e.g., temperatures above 80° C.).

Although not wanting to be bound by theory, it is believed that the coupling agents forming covalent bonds with the submicronmeter particles provide steric hinderance between subsmicronmeter particles to reduce or prevent aggregation and precipitation in solvents. Other functional groups on the coupling agents such as acrylate, methacrylate, epoxy, or vinyl may further enhance the dispersion of the functionalized submicronmeter particles in coating monomers or oligomers and in solvents.

In some embodiments, articles described herein, the layer further comprises in the range from 0.01 wt. % to 0.5 wt. % particles in the range from 1 micrometer to 10 micrometer particle in size. In some embodiments, articles described herein, the layer further comprises at least one of wax, polytetrafluoroethylene (PTFE), polymethylmethacrylate (PMMA), polystyrene, polylactic acid (PLA), or silica. These micro-scale particles can be functionalized with the coupling agents described above and dispersed in coating solutions by a blender or sonicator. The particles are typically added to coating resin binders in an amount in the range of 0.01-0.5 wt. %, based on the total solids content of the coating. Although not wanting to be bound by theory, it is believed that the particles can form “undulation” (wavy protrusions/recesses) over the entire surface of the nanostructured material to form a surface shape which provided the anti-Newton ring property when in contact with the surface of another material. This anti-Newton method can also be applied with other antireflective technologies such as traditional subwavelength scale surface gratings, multilayer antireflective coatings, ultra-low or low refractive index coatings using nano hollow sphere, porous fumed silica, or any other nanoporous coating methods to provide anti-Newton antireflective functionalities. Further details can be found, for example, in U.S. Pat. No. 6,592,950 (Toshima et al.), the disclosure of which is incorporated herein by reference.

In some embodiments, the material comprising the first and second regions is a layer. In some embodiments, this layer is attached to a substrate.

Exemplary substrates include polymeric substrates, glass substrates or windows, and functional devices (e.g., organic light emitting diodes (OLEDs), displays, and photovoltaic devices). Typically, the substrates have thicknesses in a range from about 12.7 micrometers (0.0005 inch) to about 762 micrometers (0.03 inch), although other thicknesses may also be useful.

Exemplary polymeric materials for the substrates include polyethylene terephthalate (PET), polystyrene, acrylonitrile butadiene styrene, polyvinyl chloride, polyvinylidene chloride, polycarbonate, polyacrylates, thermoplastic polyurethanes, polyvinyl acetate, polyamide, polyimide, polypropylene, polyester, polyethylene, poly(methyl methacrylate), polyethylene naphthalate, styrene acrylonitrile, silicone-polyoxamide polymers, fluoropolymers, triacetate cellulose, cyclic olefin copolymers, and thermoplastic elastomers. Semicrystalline polymers (e.g., polyethylene terephthalate (PET)) may be particularly desirable for the applications requiring good mechanical strength and dimensional stability. For other optical film applications, low birefringent polymeric substrates, such as triacetate cellulose, poly(methyl methacrylate), polycarbonate, and cyclic olefin copolymers, may be particularly desirable to minimize or avoid orientation induced polarization or dichroism interference with other optical components, such as polarizer, electromagnetic interference, or conductive touch functional layer in the optical display devices.

The polymeric substrates can be formed, for example, by melt extrusion casting, melt extrusion calendaring, melt extrusion with biaxial stretching, blown film processes, and solvent casting optionally with biaxial stretching. In some embodiments, the substrates are highly transparent (e.g., at least 90% transmittance in the visible spectrum) with low haze (e.g., less than 1%) and low birefringence (e.g., less than 50 nanometers optical retardance). In some embodiments, the substrates have a microstructured surface or fillers to provide hazy or diffusive appearance.

Optionally, the substrate is a polarizer (e.g., a reflective polarizer or an absorptive polarizer). A variety of polarizer films may be used as the substrate, including multilayer optical films composed, for example, of some combination of all birefringent optical layers, some birefringent optical layers, or all isotropic optical layers. The multilayer optical films can have ten or less layers, hundreds, or even thousands of layers. Exemplary multilayer polarizer films include those used in a wide variety of applications such as liquid crystal display devices to enhance brightness and/or reduce glare at the display panel. The polarizer film may also be the type used in sunglasses to reduce light intensity and glare. The polarizer film may comprise a polarizer film, a reflective polarizer film, an absorptive polarizer film, a diffuser film, a brightness enhancing film, a turning film, a mirror film, or a combination thereof. Exemplary reflective polarizer films include those reported in U.S. Pat. No. 5,825,543 (Ouderkirk et al.) U.S. Pat. No. 5,867,316 (Carlson et al.), U.S. Pat. No. 5,882,774 (Jonza et al.), U.S. Pat. No. 6,352,761 B1 (Hebrink et al.), U.S. Pat. No. 6,368,699 B1 (Gilbert et al.), and U.S. Pat. No. 6,927,900 B2 (Liu et al.), U.S. Pat. Appl. Pub. Nos. 2006/0084780 A1 (Hebrink et al.), and 2001/0013668 A1 (Neavin et al.), and PCT Pub. Nos. WO95/17303 (Ouderkirk et al.), WO95/17691 (Ouderkirk et al), WO95/17692 (Ouderkirk et al.), WO95/17699 (Ouderkirk et al.), WO96/19347 (Jonza et al.), WO97/01440 (Gilbert et al.), WO99/36248 (Neavin et al.), and WO99/36262 (Hebrink et al.), the disclosures of which are incorporated herein by reference. Exemplary reflective polarizer films also include those commercially available from 3M Company, St. Paul, Minn., under the trade designations “VIKUITI DUAL BRIGHTNESS ENHANCED FILM (DBEF)”, “VIKUITI BRIGHTNESS ENHANCED FILM (BEF)”, “VIKUITI DIFFUSE REFLECTIVE POLARIZER FILM (DRPF)”, “VIKUITI ENHANCED SPECULAR REFLECTOR (ESR)”, and “ADVANCED POLARIZER FILM (APF)”. Exemplary absorptive polarizer films are commercially available, for example, from Sanritz Corp., Tokyo, Japan, under the trade designation of “LLC2-5518SF”.

The optical film may have at least one non-optical layer (i.e., a layer(s) that does not significantly participate in the determination of the optical properties of the optical film). The non-optical layers may be used, for example, to impart or improve mechanical, chemical, or optical, properties; tear or puncture resistance; weatherability; or solvent resistance.

Exemplary glass substrates include sheet glass (e.g., soda-lime glass) such as that made, for example, by floating molten glass on a bed of molten metal. For display applications glass such as liquid crystal display glass, borosilicate glass, chemically strengthened glass, and the like are also useful. In some embodiments (e.g., for architectural and automotive applications), it may be desirable to include a low-emissivity (low-E) coating on a surface of the glass to improve the energy efficiency of the glass. Other coatings may also be desirable in some embodiments to enhance the electro-optical, catalytic, or conducting properties of glass.

A method for making articles described herein comprises:
providing a composition comprising polymeric precursor and optional solvent;
penetrating at least a portion of the polymeric precursor and optional solvent into a material through the first major surface of the material and providing a layer of the composition on the first major surface of the material;
removing the solvent if present (e.g., by drying); and
at least partially curing the polymeric precursor to provide a polymeric matrix. In some embodiments, the composition further comprises nanoscale phase dispersed therein. In some embodiments, the solvent comprises methoxy propanol and methyl ethyl ketone; methoxy propanol and ethyl acetate; methoxy propanol and methyl isobutyl ketone; acetone and methyl ethyl ketone; acetone and ethyl acetate; acetone and methyl isobutyl ketone; isopropanol and methyl ethyl ketone; isopropanol and ethyl acetate; and isopropanol and methyl isobutyl ketone (in some embodiments, present in a weight ratio in a range from 60:40 to 75:25).

Factors affecting the surface swelling of materials such as polymeric materials may include the plasticization and thermodynamic compatibility between the material and the coating composition, including monomers and optional solvent. Solvent quality is a measure of the closeness of the thermodynamic parameters of solvent to those of polymeric materials. “Solvent” as used herein refers to both organic solvents (including those listed above) and the monomers in the polymerizable resin. A co-solvent mixture can be used in which the polymer coil is more effective solvated than in either of the two separate liquids, which in turn can effectively swell the surface of polymeric material to facilitate penetration of polymerizable precursor in a mixture comprising the co-solvent into the surface of polymeric materials. Upon drying and curing the polymerizable precursor can be further cured forming an interpenetration interphase layer near the major surface of the polymeric material. Thus the interpenetration interphase layer comprises components of both the substrate and the polymerizable resin. The formation of an interpenetration interphase provides a stronger interfacial bonding between the layer on the major surface of the material, and an effective refractive index to minimize interfacial reflection between the layer and the material, which in turn improve coating quality and optical appearance of the coated article.

In another aspect, the present disclosure describes a method of making articles described herein, the method comprising:
providing a composition comprising polymeric precursor and optional solvent;
penetrating at least a portion of the polymeric precursor and optional solvent into a material through the first major surface of the material and providing a layer of the composition on the first major surface of the material;
at least partially curing the polymeric precursor in the material to provide the single phase polymeric material and polymeric matrix with the nanoscale phase dispersed in a layer; and
anisotropically etching at least a portion of the polymeric matrix using plasma (e.g., a O₂, Ar, CO₂, O₂/Ar, O₂/CO₂, C₆F₁₄/O₂, or C₃F₈/O₂ plasma) to form the random anisotropic nanostructured surface. In some embodiments, the solvents comprises methoxy propanol and methyl ethyl ketone; methoxy propanol and ethyl acetate; methoxy propanol and methyl isobutyl ketone; acetone and methyl ethyl ketone; acetone and ethyl acetate; acetone and methyl isobutyl ketone; isopropanol and methyl ethyl ketone; isopropanol and ethyl acetate; and isopropanol and methyl isobutyl ketone (in some embodiments, present in a weight ratio in a range from 60:40 to 75:25). In some embodiments, the nanostructured surface is treated at least a second time with plasma (e.g., O₂, Ar, CO₂, O₂/Ar, O₂/CO₂, C₆F₁₄/O₂, or C₃F₈/O₂ plasma). In some embodiments, the method is performed roll-to-roll using cylindrical reactive ion etching. In some embodiments, etching is carried out at a pressure of about 1 mTorr to about 20 mTorr.

In some embodiments, the matrix is etched to a depth of at least in a range from 100 nm to 500 nm. Highly directional ionized plasma etching under high vacuum with high biased voltage is typically needed to enable deeper etching for greater than 200 nm. Effective directional reactive and physical ions bombardments are formed under high vacuum and biased voltage to allow deeper penetration of plasma into the surface while minimizing side etching.

In another aspect, nanostructured materials described herein have a reflection less than 2 percent (in some embodiments, less than 1.5 percent or even less than 0.5 percent) as measured by Procedure 2 in the Examples below. The nanostructured materials described herein can have a haze less than 3 percent (in some embodiments, less than 2 percent, 1.5 percent, or even less than 1 percent) as measured by Procedure 3 in the Examples below.

Optionally, articles described herein further comprise a functional layer (i.e., at least one of a transparent conductive layer or a gas barrier layer) as described, for example, in PCT Appl. Nos. US2011/026454, filed Feb. 28, 2011, and U.S. Pat. Appl. Nos. 61/452,403 and 61/452,430, filed Mar. 14, 2011, the disclosures of which are incorporated herein by reference).

Optionally, articles described herein further comprise an optically clear adhesive disposed on the second surface of the substrate. The optically clear adhesives that may be used in the present disclosure preferably are those that exhibit an optical transmission of at least about 90%, or even higher, and a haze value of below about 5% or even lower, as measured on a 25 micrometer thick sample in the matter described below in the Example section under the Haze and Transmission Tests for optically clear adhesive. Suitable optically clear adhesives may have antistatic properties, may be compatible with corrosion sensitive layers, and may be able to be released from the substrate by stretching the adhesive. Illustrative optically clear adhesives include those described in PCT Pub. No. WO 2008/128073 (Everaerts et al.) relating to antistatic optically clear pressure sensitive adhesive; U.S. Pat. Appl. Pub. No. US 2009/0229732A1 (Determan et al.) relating to stretch releasing optically clear adhesive; U.S. Pat. Appl. Pub. No. US 2009/0087629 (Everaerts et al.) relating to indium tin oxide compatible optically clear adhesive; U.S. Pat. Appl. Pub. No. US 2010/0028564 (Everaerts et al.) relating to antistatic optical constructions having optically transmissive adhesive; U.S. Pat. Appl. Pub. No. 2010/0040842 (Everaerts et al.) relating to adhesives compatible with corrosion sensitive layers; PCT Pub. No. WO 2009/114683 (Determan et al.) relating to optically clear stretch release adhesive tape; and PCT Pub. No. WO 2010/078346 (Yamanaka et al.) relating to stretch release adhesive tape. In one embodiment, the optically clear adhesive has a thickness of up to about 5 micrometer.

In some embodiments, articles described herein further comprise a hardcoat comprising at least one of SiO₂ nanoparticles or ZrO₂ nanoparticles dispersed in a crosslinkable matrix comprising at least one of multi(meth)acrylate, polyester, epoxy, fluoropolymer, urethane, or siloxane (which includes blends or copolymers thereof). Commercially available liquid-resin based materials (typically referred to as “hardcoats”) may be used as the matrix or as a component of the matrix. Such materials include that available from California Hardcoating Co., San Diego, Calif., under the trade designation “PERMANEW”; and from Momentive Performance Materials, Albany, N.Y., under the trade designation “UVHC”. Additionally, commercially available nanoparticle filled matrix may be used such as those available from Nanoresins AG, Geesthacht Germany, under the trade designations “NANOCRYL” and “NANOPDX”.

In some embodiments, the articles described herein further comprises a surface protection adhesive sheet (laminate premasking film) having a releasable adhesive layer formed on the entire area of one side surface of a film, such as a polyethylene film, a polypropylene film, a vinyl chloride film, or a polyethylene terephthalate film to the surface of the articles, or by superimposing the above-mentioned polyethylene film, a polypropylene film, a vinyl chloride film, or a polyethylene terephthalate film on the surface of articles.

### Exemplary Embodiments

1A. An article comprising a material having a thickness, first and second generally opposed major surfaces, and first and second regions across the thickness, wherein the first region is adjacent the first major surface, a layer comprising a polymeric material on the first major surface, and the polymeric material also present within the first region as a single phase with the substrate, and wherein the thickness of the first region is at least 0.01 micrometer (in some embodiments, at least 0.025 micrometer, 0.05 micrometer, 0.075 micrometer, 0.1 micrometer, 0.5 micrometer, 1 micrometer, 1.5 micrometer, or even at least 2 micrometers; or even in a range from 0.01 micrometer to 0.3 micrometer, 0.025 micrometer to 0.3 micrometer, 0.05 micrometer to 0.3 micrometer, 0.075 micrometer to 0.3 micrometer, or 0.1 micrometer to 0.3 micrometer).
2A. The article of Embodiment 1A, wherein the layer comprises a nanoscale phase dispersed in the polymeric material.
3A. The article of Embodiment 2A, wherein the nanoscale phase is present in a range from 60 nm to 90 nm in size, in a range from 30 nm to 50 in size, and less than 25 nm in size, and wherein the nanoscale phase is present in the range from 0.25 wt. % to 50 wt. % (in some embodiments, 1 wt. % to 25 wt. %, 5 wt. % to 25 wt. %, or even 10 wt. % to 25 wt. %) for sizes in the range from 60 nm to 90 nm, 1 wt. % to 50 wt. % (in some embodiments, 1 wt. % to 25 wt. %, or even 1 wt. % to 10 wt. %) for sizes in a range from 30 nm to 50 nm, and 0.25 wt. % to 25 wt. % (in some embodiments, 0.5 wt. % to 10 wt. %, 0.5 wt. % to 5 wt. %, or even 0.5 wt. % to 2 wt. %) for sizes less than 25 nm, based on the total weight of the matrix and nanoscale phase.
4A. The article of either Embodiment 2A or 3A, wherein the nanoscale phase is present in a range from 60 nm to 90 nm in size, in a range from 30 nm to 50 in size, and less than 25 nm in size, and wherein the nanoscale phase is present in the range from 0.1 vol. % to 35 vol. % (in some embodiments, 0.5 vol. % to 25 vol. %, 1 vol. % to 25 vol. %, or even 3 vol. % to 15 vol. %) for sizes in the range from 60 nm to 90 nm, 0.1 vol. % to 25 vol. % (in some embodiments, 0.25 vol. % to 10 vol. %, or even 0.25 vol. % to 5 vol. %) for sizes in a range from 30 nm to 50 nm, and 0.1 vol. % to 10 vol. % (in some embodiments, 0.25 vol. % to 10 vol. %, or even 0.1 vol. % to 2.5 vol. %) for sizes less than 25 nm, based on the total volume of the matrix and nanoscale phase.
5A. The article of any of Embodiments 2A to 4A, wherein the nanoscale phase is present in a range from 1 nm to 100 nm in size, and wherein the nanoscale phase is present in less than 1.25 wt. % (in some embodiments, less 1 wt, 0.75 wt. %, 0.5 wt. %, or even less than 0.35 wt. %), based on the total weight of the matrix and nanoscale phase.
6A. The article of any of Embodiments 2A to 5A, wherein the nanoscale phase comprises submicrometer particles.
7A. The article of Embodiment 6A, wherein the submicrometer particles have an average particle size in a range from 1 nm to 100 nm (in some embodiments, 1 nm to 75 nm, 1 nm to 50 nm, or even 1 nm to 25 nm).
8A. The article of either Embodiment 6A or 7A, wherein the submicrometer particles are covalently bonded to the polymeric matrix.
9A. The article of any of Embodiments 6A to 8A, wherein at least some of the submicrometer particles are functionalized with at least one multifunctional silane coupling agent comprising silanol and at least one of acrylate, epoxy, or vinyl functional groups.
10A. The article of any of Embodiments 6A to 9A, wherein the submicrometer particles comprise at least one of carbon, metal, metal oxide, metal carbide, metal nitride, or diamond.
11A. The article of any preceding Embodiment A, wherein the polymeric material present within the first region is in a range from 5 wt. % to 75 wt. %, based on the total weight of the region including the polymeric material.
12A. The article of any Embodiment A, wherein the layer exhibits a random anisotropic nanostructured surface.
13A. The article of Embodiment 12A, wherein the nanostructured anisotropic surface comprises nanoscale features having a height to width ratio of at least 2:1 (in some embodiments, at least 5:1, 10:1, 25:1, 50:1, 75:1, 100:1, 150:1, or even at least 200:1).
14A. The article of any preceding Embodiment A, wherein the layer further comprises in the range from 0.01 wt. % to 0.5 wt. % particles in the range from 1 micrometer to 10 micrometer particle in size.
15A. The article of Embodiment 14A, wherein the layer further comprises at least one of wax, polytetrafluoroethylene, polymethylmethacrylate, polystyrene, polylactic acid, or silica.
16A. The article of any preceding Embodiment A exhibiting an average reflection at 60 degrees off angle less than 1 percent (in some embodiments, less than 0.75 percent, 0.5 percent, 0.25 percent, or less than 0.2 percent).
17A. The article of any preceding Embodiment A, wherein at least a portion of the polymeric material comprises at least one of tetrafluoroethylene, vinylfluoride, vinylidene fluoride, chlorotrifluoroethylene, perfluoroakoxy, fluorinated ethylene-propylene, ethylenetetrafluoroethylene, ethylenechlorotrifluoroethylene, perfluoropolyether, perfluoropolyoxetane, hexafluoropropylene oxide, siloxane, organosilicon, siloxides, ethylene oxide, propylene oxide, hydroxyl, hydroxylamine, acrylamide, acrylic acid, maleic anhydride, vinyl acid, vinyl alcohol, vinylpyridine, or vinypyrrolidone.
18A. The article of any preceding Embodiment A, wherein the material comprises at least one of polyethylene terephthalate (PET), polystyrene, acrylonitrile butadiene styrene, polyvinyl chloride, polyvinylidene chloride, polycarbonate, polyacrylates, thermoplastic polyurethanes, polyvinyl acetate, polyamide, polyimide, polypropylene, polyester, polyethylene, poly(methyl methacrylate), polyethylene naphthalate, styrene acrylonitrile, silicone-polyoxamide polymers, fluoropolymers, triacetate cellulose, cyclic olefin copolymers, or thermoplastic elastomers
19A. The article of any preceding Embodiment A, wherein the polymeric material (e.g., cross linkable material) comprises at least one of acrylate, urethane acrylate, methacrylate, polyester, epoxy, fluoropolymer, or siloxane.
20A. The article of any preceding Embodiment A, wherein the layer has a thickness of at least 500 nm (in some embodiments, at least 1 micrometer, 1.5 micrometer, 2 micrometer, 2.5 micrometers, 3 micrometers, 4 micrometers, 5 micrometers, 7.5 micrometers, or even at least 10 micrometers
21A. The article of any preceding Embodiment A, wherein the material comprising first and second regions is a layer.
22A. The article of Embodiment 21A, wherein the layer of material comprising first and second regions is attached to a major surface of a substrate.
23A. The article of any preceding Embodiment A, wherein the substrate is a polarizer (e.g., reflective polarizer or absorptive polarizer).
24A. The article of any preceding Embodiment A, wherein the first major surface of the substrate has a microstructured surface.
25A. The article of any preceding Embodiment A having a haze less than 3 percent (in some embodiments, less than 2.5 percent, 2 percent, 1.5 percent, 1 percent, 0.75 percent, 0.5 percent, or even less than 0.3 percent).
26A. The article of any preceding Embodiment A having a visible light transmission of at least 90 percent (in some embodiments, at least 94 percent, 95 percent, 96 percent, 97 percent, 98 percent, 99 percent, or even 100 percent).
27A. The article of any preceding Embodiment A further comprising a hardcoat comprising at least one of SiO₂ nanoparticles or ZrO₂ nanoparticles dispersed in a crosslinkable matrix comprising at least one of multi(meth)acrylate, polyester, epoxy, fluoropolymer, urethane, or siloxane.
28A. The article of any preceding Embodiment A, further comprising a pre-mask film disposed on the layer.
29A. The article of any of Embodiments 1A to 27A, further comprising an optically clear adhesive disposed on the second surface of the substrate, the optically clear adhesive having at least 90% transmission in visible light and less than 5% haze.
30A. The article of Embodiment 29A further comprising a major surface of a glass substrate attached to the optically clear adhesive.
31A. The article of Embodiment 29A, further comprising a major surface of a polarizer substrate attached to the optically clear adhesive.
32A. The article of Embodiment 29A further comprising a major surface of a touch sensor attached to the optically clear adhesive.
33A. The article of Embodiment 29A, further comprising a release liner disposed on the second major surface of the optically clear adhesive.
1B. A method of making the article of any of Embodiments 1A to 26A, the method comprising:
providing a composition comprising polymeric precursor and optional solvent;
penetrating at least a portion of the polymeric precursor and optional solvent into a material through the first major surface of the material and providing a layer of the composition on the first major surface of the material;
removing the solvent (e.g., by drying); and
at least partially curing the polymeric precursor to provide a polymeric matrix.
   2B. The method of Embodiment 1B, wherein the solvent is present is and is at least one of methoxy propanol and methyl ethyl ketone; methoxy propanol and ethyl acetate; methoxy propanol and methyl isobutyl ketone; acetone and methyl ethyl ketone; acetone and ethyl acetate; acetone and methyl isobutyl ketone; isopropanol and methyl ethyl ketone; isopropanol and ethyl acetate; or isopropanol and methyl isobutyl ketone (in some embodiments, present in a weight ratio in a range from 60:40 to 75:25).
   3B. The method of either Embodiment 1B or 2B, wherein the matrix is etched to a depth of at least in a range from 100 nm to 500 nm.
   1C. A method of making the article of any of Embodiments 2A to 26A, the method comprising:
providing a composition comprising polymeric precursor, solvent, and nanoscale phase;
penetrating at least a portion of the polymeric precursor and optional solvent into a material through the first major surface of the material and providing a layer of the composition on the first major surface of the material;
at least partially curing the polymeric precursor in the material to provide the single phase polymeric material and polymeric matrix with the nanoscale phase dispersed in a layer; and
anisotropically etching at least a portion of the polymeric matrix using plasma to form the random anisotropic nanostructured surface.
   2C. The method of Embodiment 1C, wherein the solvent is present and is at least one of methoxy propanol and methyl ethyl ketone; methoxy propanol and ethyl acetate; methoxy propanol and methyl isobutyl ketone; acetone and methyl ethyl ketone; acetone and ethyl acetate; acetone and methyl isobutyl ketone; isopropanol and methyl ethyl ketone; isopropanol and ethyl acetate; or isopropanol and methyl isobutyl ketone (in some embodiments, present in a weight ratio in a range from 60:40 to 75:25).
   3C. The method of Embodiment either Embodiment 1C or 2C further comprising treating the nanostructured surface with plasma a second time.
   4C. The method of any preceding Embodiment C, wherein the method is performed roll-to-roll using cylindrical reactive ion etching.
   5C. The method of any preceding Embodiment C, wherein the etching is carried out at a pressure of about 1 mTorr to about 20 mTorr.
   6C. The method of any preceding Embodiment C, wherein the plasma is O₂, Ar, CO₂, O₂/Ar, O₂/CO₂, C₆F₁₄/O₂, or C₃F₈/O₂ plasma.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

### Procedure 1—Plasma Treatment of Roll-to-Roll Samples

The cylindrical RIE apparatus shown in FIG. 1 of PCT Pub. No. WO2010/078306A2 (Moses et al.), the disclosure of which is incorporated by reference, was used to treat polymeric film. The width of the drum electrode was 42.5 inches (108 cm). Pumping was carried out by means of a turbo-molecular pump.

Rolls of the polymeric film were mounted within the chamber, the film wrapped around the drum electrode and secured to the take up roll on the opposite side of the drum. The unwind and take-up tensions were maintained at 3 pounds (13.3 N). The chamber door was closed and the chamber pumped down to a base pressure of 5×10⁻⁴ Torr. Oxygen was then introduced into the chamber. The operating pressure was nominally 5 mTorr. Plasma was generated by applying a power of 5000 watts of radio frequency energy to the drum. The drum was rotated so that the film was transported at a desired speed for the specific etching time as stated in the specific example. For a piece-part film, the sample is either attached to a web carrier or to the surface of drum electrode to be treated at a desired speed for the specific etching time as stated in the specific example.

### Procedure 2—Measurement of 60° Off Angle Average % Reflection

The average % reflection (% R) of the plasma treated surface was measured using a UV/Vis/NIR Scanning Spectrophotometer (obtained from PerkinElmer. Walthan, Mass., under the trade designation “PERKINELMER LAMBDA 950 URA UV-VIS-NIR SCANNING SPECTROPHOTOMETER”). One sample of each film was prepared by applying black vinyltape to the backside of the sample. The black tape was laminated to the backside of the sample using a roller to ensure there were no air bubbles trapped between the black tape and the sample. The front surface % reflection (specular) of a sample was measured by placing the sample in the machine so that the non-tape side was against the aperture. The % reflection was measured at a 60° off angle and average % reflection was calculated for the wavelength range of 400-700 nm.

### Procedure 3—Measurement of Transmission and Haze

The measurement of average % transmission and haze was carried with a haze meter (obtained under the trade designation “BYK HAZEGARD PLUS” from BYK Gardiner) according to ASTM D1003-11 (2011), the disclosures of which are incorporated herein by reference.

### Coating Monomers and Photo-Initiator

Trimethylolpropantriacrylate (TMPTA) and 1,6-hexanediol diacrylate (HDDA) were obtained from Sartomer, under the trade designation “SR351” and “SR238”, respectively. Photoinitiator was obtained from BASF Specialty Chemicals under the trade designation “IRGACURE 184”).

### Functionalized 15 nm SiO₂ Dispersion

A dispersion of functionalized 15 nm SiO₂ dispersed in UV curable resin comprising photo-initiator was obtained from Momentive Performance Materials, Wilton, Conn., under the trade designation “UVHC8558”). The weight percentage of 15 nm SiO₂ in the dispersion is about 20 wt. %.

### Functionalized 20 nm SiO₂ Dispersion

A trimethylolpropantriacrylate (TMPTA) dispersion comprising 50 wt. % 20 nm silica nanoparticles (obtained from Hanse Chemie USA, Inc. Hilton Head Island, S.C., under the trade designation “NANOCRYL C150”).

### Coating Solutions

Coating compositions utilized for the following examples are provided in Table 1, below.

TABLE 1

| | Coating Compositions (grams) | | | |
|---|---|---|---|---|
| | Composi- | Composi- | Composi- | Composi- |
| | tions 1 | tions 2 | tions 3 | tions 4 |
| UVHC8558 | 500 | 100 | 25 | 0 |
| 351 | 350 | 630 | 682.5 | 400 |
| 238 | 150 | 270 | 292.5 | 0 |
| NANOCRYL C150 | 0 | 0 | 0 | 100 |
| 1-methoxy-2-propanol | 1050 | 1050 | 1050 | 400 |
| methyl ethyl ketone | 450 | 450 | 450 | 0 |
| Isopropanol | 0 | 0 | 0 | 1600 |
| IRGACURE 184 | 0 | 0 | 0 | 10 |

### Examples 1-3

Compositions 1-3 were pumped into a coating die and applied on to 80 micrometer thick triacetate cellulose films (obtained from FujiFilm Corporation, Tokyo, Japan, under the trade designation “FUJI TAC FILM”). The coated substrates were dried by passing through an oven set at 70° C. and then cured by a UV source at 60 fpm (18.3 meters/minute). The coated samples were observed with transmission electron microscopy (TEM) to have interpenetration interphase in a (inner) region of the film.

### Example 4

Composition 1 was pumped into a coating die and applied on to 80 micrometer thick triacetate cellulose films (obtained from Island Pyrochemical Industries Corp, Mineola, N.Y., under the trade designation “IPI TAC”). The coating was dried by passing through an oven set at 70° C. and then cured by a UV source at 60 fpm (18.3 meters/minute). The coated sample was observed with transmission electron microscopy (TEM) to have interpenetration interphase in a (inner) region of the film (see FIG. 2 showing article 20 with material having first and second regions 24, 22, respectively, and polymeric material 26.

### Examples 5-7

Composition 2 was pumped into a coating die and applied on to 80 micrometer thick triacetate cellulose films (“FUJI TAC FILM”). The coating was dried by passing through an oven set at 70° C. and then cured by a UV source at 60 fpm (18.3 meters/minute). This sample was treated by Procedure 1 for different etching times—150 seconds, 180 seconds, and 300 seconds. The samples after etching were evaluated by Procedures 2 and 3. The results are reported in Table 2, below.

TABLE 2

| | Etching | 60 degree | | |
|---|---|---|---|---|
| | time (s) | ave % R | Transmission | Haze |
| Example 5 | 150 | 0.45 | 97.3 | 0.42 |
| Example 6 | 180 | 0.48 | 97.2 | 0.44 |
| Example 7 | 300 | 0.52 | 97.1 | 0.7 |

### Examples 8-10

Composition 3 was pumped into a coating die and applied on to 80 micrometer thick triacetate cellulose films (“FUJI TAC FILM”). The coating was dried by passing through an oven set at 70° C. and then cured by a UV source at 60 fpm (18.3 meters/minute). This sample was treated by Procedure 1 for different etching times—150 seconds, 180 seconds, and 300 seconds. The samples after etching were evaluated by Procedures 2 and 3. The results are reported in Table 3, below.

TABLE 3

| | Etching | 60 degree | | |
|---|---|---|---|---|
| | time (s) | ave % R | Transmission | Haze |
| Example 8 | 150 | 1.15 | 97.3 | 0.5 |
| Example 9 | 180 | 0.84 | 97 | 0.62 |
| Example 10 | 300 | 0.34 | 97 | 2.7 |

### Comparative Example

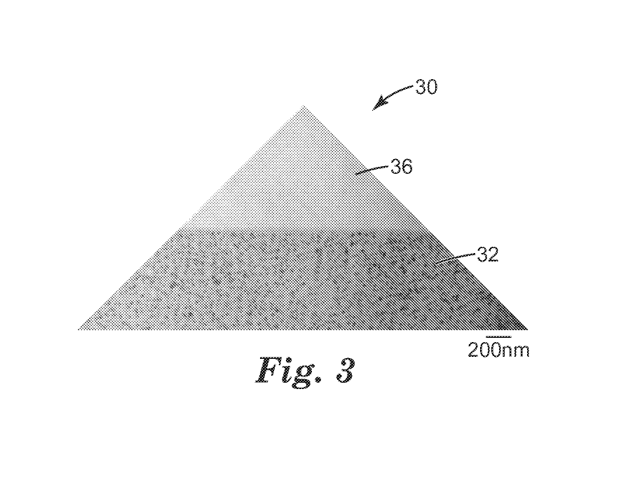

Composition 4 was pumped into a coating die and applied on to 80 micrometer thick triacetate cellulose films (“IPI TAC FILM”). The coating was dried by passing through an oven set at 120° C. and then cured by a UV source at 60 fpm (18.3 meters/minute). Many coating defects were visually observed on this sample. The sample was examined with transmission electron microscopy (TEM) and no interpenetration interphase in a (inner) region was not found (see FIG. 3 showing article 30 with material 32 and polymeric material 36.

Foreseeable modifications and alterations of this disclosure will be apparent to those skilled in the art without departing from the scope and spirit of this invention. This invention should not be restricted to the embodiments that are set forth in this application for illustrative purposes.

1. An article comprising a material having a thickness, first and second generally opposed major surfaces, and first and second regions across the thickness, wherein the first region is adjacent the first major surface, a layer comprising a polymeric material on the first major surface, and the polymeric material also present within the first region as a single phase with the substrate, wherein the thickness of the first region is at least 0.01 micrometer, wherein the layer exhibits a random anisotropic nanostructured surface, and wherein the nanostructured anisotropic surface comprises nanoscale features having a height to width ratio of at least 2:1.

2. The article of claim 1, wherein the layer comprises a nanoscale phase dispersed in the polymeric material.

3. The article of claim 2, wherein the nanoscale phase is present in a range from 60 nm to 90 nm in size, in a range from 30 nm to 50 in size, and less than 25 nm in size, and wherein the nanoscale phase is present in the range from 0.25 wt. % to 50 wt. % for sizes in the range from 60 nm to 90 nm, 1 wt. % to 50 wt. % for sizes in a range from 30 nm to 50 nm, and 0.25 wt. % to 25 wt. % for sizes less than 25 nm, based on the total weight of the matrix and nanoscale phase.

4. The article of claim 2, wherein the nanoscale phase is present in a range from 60 nm to 90 nm in size, in a range from 30 nm to 50 in size, and less than 25 nm in size, and wherein the nanoscale phase is present in the range from 0.1 vol. % to 35 vol. % for sizes in the range from 60 nm to 90 nm, 0.1 vol. % to 25 vol. % for sizes in a range from 30 nm to 50 nm, and 0.1 vol. % to 10 vol. % for sizes less than 25 nm, based on the total volume of the matrix and nanoscale phase.

5. The article of claim 2, wherein the nanoscale phase is present in a range from 1 nm to 100 nm in size, and wherein the nanoscale phase is present in less than 1.25 wt. %, based on the total weight of the matrix and nanoscale phase.

6. The article of claim 2, wherein the nanoscale phase comprises submicrometer particles.

7. A method of making the article of claim 2, the method comprising:
providing a composition comprising polymeric precursor and optional solvent;
penetrating at least a portion of the polymeric precursor and optional solvent into a material through the first major surface of the material and providing a layer of the composition on the first major surface of the material;
removing the solvent; and
at least partially curing the polymeric precursor to provide a polymeric matrix.

8. The method of claim 7, wherein the solvent is present is and is at least one of methoxy propanol and methyl ethyl ketone; methoxy propanol and ethyl acetate; methoxy propanol and methyl isobutyl ketone; acetone and methyl ethyl ketone; acetone and ethyl acetate; acetone and methyl isobutyl ketone; isopropanol and methyl ethyl ketone; isopropanol and ethyl acetate; or isopropanol and methyl isobutyl ketone.

9. The method of claim 7, wherein the matrix is etched to a depth of at least in a range from 100 nm to 500 nm.

10. A method of making the article of claim 2, the method comprising:
providing a composition comprising polymeric precursor, solvent, and nanoscale phase;
penetrating at least a portion of the polymeric precursor and optional solvent into a material through the first major surface of the material and providing a layer of the composition on the first major surface of the material;
at least partially curing the polymeric precursor in the material to provide the single phase polymeric material and polymeric matrix with the nanoscale phase dispersed in a layer; and
anisotropically etching at least a portion of the polymeric matrix using plasma to form the random anisotropic nanostructured surface.

11. The method of claim 10, wherein the solvent is present and is at least one of methoxy propanol and methyl ethyl ketone; methoxy propanol and ethyl acetate; methoxy propanol and methyl isobutyl ketone; acetone and methyl ethyl ketone; acetone and ethyl acetate; acetone and methyl isobutyl ketone; isopropanol and methyl ethyl ketone; isopropanol and ethyl acetate; or isopropanol and methyl isobutyl.

12. The article claim 6, wherein the submicrometer particles have an average particle size in a range from 1 nm to 100 nm.

13. The article of claim 12, wherein the submicrometer particles are covalently bonded to the polymeric matrix.

14. The article of claim 6, wherein at least some of the submicrometer particles are functionalized with at least one multifunctional silane coupling agent comprising silanol and at least one of acrylate, epoxy, or vinyl functional groups.

15. The article of claim 1 exhibiting an average reflection at 60 degrees off angle less than 1 percent (in some embodiments, less than 0.75 percent, 0.5 percent, 0.25 percent, or less than 0.2 percent).

16. The article of claim 1, wherein at least a portion of the polymeric material comprises at least one of tetrafluoroethylene, vinylfluoride, vinylidene fluoride, chlorotrifluoro ethylene, perfluoroakoxy, fluorinated ethylene-propylene, ethylenetetrafluoroethylene, ethylenechlorotrifluoroethylene, perfluoropolyether, perfluoropolyoxetane, hexafluoropropylene oxide, siloxane, organosilicon, siloxides, ethylene oxide, propylene oxide, hydroxyl, hydroxylamine, acrylamide, acrylic acid, maleic anhydride, vinyl acid, vinyl alcohol, vinylpyridine, or vinypyrrolidone.

17. The article claim 1, wherein the material comprises at least one of polyethylene terephthalate (PET), polystyrene, acrylonitrile butadiene styrene, polyvinyl chloride, polyvinylidene chloride, polycarbonate, polyacrylates, thermoplastic polyurethanes, polyvinyl acetate, polyamide, polyimide, polypropylene, polyester, polyethylene, poly(methyl methacrylate), polyethylene naphthalate, styrene acrylonitrile, silicone-polyoxamide polymers, fluoropolymers, triacetate cellulose, cyclic olefin copolymers, or thermoplastic elastomers.

18. The article claim 1 having a haze less than 3 percent.

19. The article of claim 1 having a visible light transmission of at least 90.
